(19) United States
(12) Patent Application Publication
(10) Pub. No.: US 2022/0032315 A1
(43) Pub. Date: Feb. 3, 2022

(54) MICROBIOLOGICAL SYSTEM FOR THE REMOVAL OF CONTAMINANTS FROM COAL

(71) Applicant: John R. Chabria, Columbus, OH (US)

(72) Inventor: John R. Chabria, Columbus, OH (US)

(21) Appl. No.: 16/940,882

(22) Filed: Jul. 28, 2020

(51) Int. Cl. B03B 9/00; C10L 9/10; B03B 5/38; B03B 5/32; B04B 3/00

(52) U.S. Cl. CPC B03B 9/005; C10L 9/10; B03B 5/38; B01D 2011/007; B04B 3/00; C10L 2250/02; B03B 5/32

(57) ABSTRACT

A system for separating coal from iron oxide and sulfur comprises a first tank having crusher to grind the coal. Steam is directed into the first tank to mix with the coal to produce a maximum substrate area for chemolithotrophic bacteria and algal species to act upon. A mechanical pulverizer is fed with the coal and steam. A sieve and a second tank receiving the coal from the pulverizer apparatus. An air exchanger connected to the second tank collects nanosized particulates of coal. A pipeline feeds the coal within the second tank with a mixture of chemolithophic bacteria from a breeding tank. A holding tank receives the mixture of coal and chemolithophic bacteria. A centrifuge receives the mixture of coal and chemolithophic bacteria from the holding tank and separates the coal from the mixture. A fourth tank receive the separated and hydrated coal particles from the centrifuge.

### FIELD OF INVENTION

The present invention relates to a system by which iron, sulfur and other impurities may be removed from coal to produce a high carbon content fuel composition, as well as separately useful quantities of iron, sulfur and other byproducts.

### BACKGROUND OF THE INVENTION

Coal, a fossil fuel, is an abundant energy source found in the eastern and western United States. Significant reserves of coal contain an iron pyrite contaminant which, when burned produces sulfur dioxide particulates, which are considered by some to mix with water vapor and produce sulfuric acid and “acid rain.” The burning of coal contaminated with iron pyrite also prevents the total combustion of the coal and inhibits the release of its maximum BTU energy potential. Present techniques for the removal of iron pyrite contaminants generally do not separate iron and sulfur from the coal as separate compositions, but rather include the elements in a sludge waste product. Microbiological techniques are known to provide such separations; however, they require extended time periods to be effective.

### SUMMARY OF THE INVENTION

It is an objective of this invention to provide a system by which contaminating iron pyrite and organic impurities may be removed from coal by a microbiological process that results in the separation of impurities at a significantly faster rate than other known systems. A decrease in pollution and an increase in energy efficiency of burned coal will thereby be achieved.

It is a further objective to provide a system by which the impurity components may be further separated from each other to create by-products in useful forms.

According to the present invention, there is disclosed a system for separating coal from iron oxide, sulfur and other impurities. The system comprises a first tank receiving the coal from a conveyor belt. A crusher to reciprocates into and out of the first tank while rotating to grind and shake the coal within the first tank. A conduit directs steam under pressure from a boiler into the first tank to mix with the ground and shaken coal to begin producing a maximum substrate area for chemolithotrophic bacteria and algal species to act upon. A mechanical pulverizer apparatus being fed with the ground and shaken coal and steam at a first end and discharging the coal through a second end. A sieve and a second tank receiving the ground and shaken coal from the mechanical pulverizer apparatus. An air exchanger and collection apparatus connected to the second tank by a conduit collects nanosized particulates of coal. A pipeline feeds the coal within the second tank with a mixture of chemolithophic bacteria from a breeding tank. A holding tank receives the mixture of coal and chemolithophic bacteria. A centrifuge receives the mixture of coal and chemolithophic bacteria from the holding tank and separates the coal from the mixture. A fourth tank receives the separated and hydrated coal particles from the centrifuge.

### BRIEF DESCRIPTION OF THE DRAWINGS

The structure, operation, and advantages of the present invention will become further apparent upon consideration of the following description taken in conjunction with the accompanying figures (Figs.). The figures are intended to be illustrative, not limiting. Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

In the drawings accompanying the description that follows, both reference numerals and legends (labels, text descriptions) may be used to identify elements. If legends are provided, they are intended merely as an aid to the reader, and should not in any way be interpreted as limiting.

FIG. 1 is a schematic diagram of an apparatus for removing contaminating iron pyrite and organic impurities from coal by a microbiological process configuration, in accordance with the present invention.

FIG. 2 shows an apparatus for removing contaminating iron pyrite and organic impurities from coal by a microbiological process incorporating a multiple stage process, in accordance with the present invention.

### DESCRIPTION OF THE PREFERRED EMBODIMENT

The structure, operation, and advantages of the present invention will become further apparent upon consideration of the following description taken in conjunction with the accompanying figures (Figs.). The figures are intended to be illustrative, not limiting. Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

In the drawings accompanying the description that follows, both reference numerals and legends (labels, text descriptions) may be used to identify elements. If legends are provided, they are intended merely as an aid to the reader, and should not in any way be interpreted as limiting.

Coal contaminated with iron pyrite, organic sulfurs and other impurities is crushed and mixed with acidified bog water under pressure and then introduced to a media comprising a mixture of selected chemolithotrophic bacteria and algal species. Bacterial action separates the iron, sulfur and other impurities from the coal and binds the organic and inorganic elements to oxygen, forming sulfate and metallic oxides and/or hydroxides. Centrifugation then separates the coal fines from the oxidized impurities, which are trapped in a mat of bacterial produced lipophosphates. The hydrophobic characteristic of “clean” coal fines causes them to rise to the top of a separator tank, while the heavier impurity laden mat sinks to the bottom of the separator tank. The discarded mat can then be processed to reduce oxides and/or hydroxides, making sulfur and heavy metals reclaimable. The end result is a “clean” composition of a high carbon coal.

In the preferred embodiment, a high sulfur coal from the mines is provided in an aqueous mixture with a selected group of bacteria: Thiobacillus ferrooxidans, Thiobacillus thiooxidans, Thiobacillus thioparus, Thiobacillus neopolitanus, and Thiobacillus acidophilis maintained at temperature of between 20 and 35 degrees Celsius at atmospheric pressure. While temperature and pressure are not critical, it is noted that a higher temperature or pressure will increase the speed of processing. The amount of bacteria employed and time of reaction will vary depending on the amount of contaminant iron and sulfur assumed to be in the coal. Oxygen is supplied to support aerobic bacteria in the form of Euglenoid algal species; aeration, glutathione reductase, and a Redox catalyst such as Bovine cytochrome “C” (or other appropriate sulfhydrase) is added as an oxidizing agent. EDTA is added as a non-specific iron chelator to further speed the process by increasing the redox potential to an optimum range, which is from 300 to 700 millivolts for iron and from 200 to 500 millivolts for sulfur. Depending upon the amount of iron pyrite in the coal, the time required to remove the iron, sulfur and other impurities from the coal and to chelate these compositions to the lipo-phosphate mat from the bacterium and to oxidize them will take from 3 to 5 hours. The mixture is then centrifuged to separate the coal from the iron oxide, sulfur and other impurities.

A magnetic attraction means introduced into the lipophosphate mat and its oxidized impurities in the centrifuge tank will remove iron compositions; rust (formed ferric compounds) may be removed from the separated iron by running the mat through a carbonized steam bath. Sulfur is reduced to hydrogen sulfide, which is further broken down into hydrogen gas and elemental sulfur, which is insoluble in water. The sulfur is suctioned off and then dried.

After removal of the impurity-laden mat, the coal-water slurry is moved into a neutralization tank and/or other station for drying and compaction before combustion or mixed with oil and blown into the boiler.

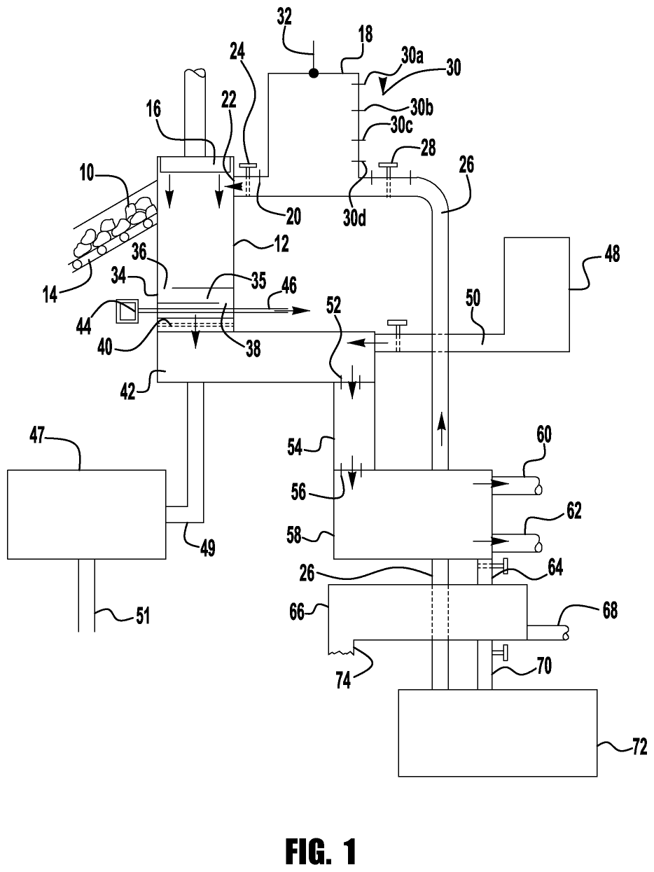

In the embodiment of FIG. 1, coal 10 such as directly from a mine is fed to a first tank 12, having a cylindrical shape, with a conveyor belt 14. The coal 10 is crushed and mixed with steam under pressure in tank 12 to begin the process of producing a maximum substrate area for the chemolithotrophic bacteria to act upon. A crusher 16 is pressed into the first tank 12 to and reciprocates into and out of the first tank 12 while rotating to grind and shake the coal within the crusher. At the same time steam is directed from a boiler 18 through a pipeline 20 into an inlet opening 22 of the first tank 12. The steam from recycled water has a PH of about 7. A shutoff valve 24 is provided in the pipeline 20 to control the input of steam from the boiler 18 into the inlet opening 22 of the first tank 12. The boiler 18 receives recycled water through line 26 which is controlled by a valve 28. At least four remote level indicators 30 including 30a, 30b, 30c and 30d, are mounted on the boiler 18. The remote level indicators 30 allow for variable control of the steam in the boiler to increase the efficiency of the coal being mixed with the steam in the tank 12. A remote level indicator 32 is disposed on the upper end of the boiler 18 also allows the condition of the steam to be monitored.

Once the coal has been ground and shaken while being mixed with steam in the first tank 12, it naturally drops towards the bottom of the tank 12 where it is directed into a mechanical pulverizer apparatus 34 such as one where the coal is fed into a rotating cylinder 35 containing steel balls of around 25 to 75 mm diameter. When the cylinder 35 rotates, the balls rotate along with the cylinder and fall down when they reach the top position. The coal feeds into the cylinder axially at one side 36 and discharges through the other side 38 at a size of about 1 mm to 16 mm. The steam carries the coal through the tube so that it exits through opening 38 into the bottom of the first tank 12. The smaller sized pieces of about 1 mm to 16 mm drop with water through a sieve 40 and enter a second tank 42 The larger pieces of coal, i.e., above 16 mm collect on the upper surface of the sieve 40 and are blown by a blower 44 through an outlet conduit 46 where they can be collected and reprocessed.

An air exchanger and collection apparatus 47 is connected to the second tank 42 by a conduit 49 to collect nanosized particulates. The collected nanosized particulates can be directed through a conduit 51 to a fluidized bed or direct boiler feed.

Second tank 42 is fed through a conduit 50 a mixture of chemolithophic bacteria including Thiobacillus thiooxidans, Thiobacillus ferrooxidans, and Thiobacillus thioparus, and the bacterium Thiobacillus neopolitanus from a breeding tank 48. Compositions separated from the coal in second tank 42 including Fe₂O₃ and sulfur bind to the pili, i.e. filamentous projections on the bacterial cells for adhering to other bacterial cells, of the bacteria. The pili of T. thioparus and T. thiooxidans display an affinity for sulfur and the pili of T. ferrooxidans display an affinity for iron. T. neopolitanus appears to produce one or more enzymes which speed the reproduction rate of the others. The process is further improved by photosynthetic growth of the algae of Euglena.

After the introduction of the bacteria through the conduit 50 to the ground coal, the mixture is then directed through an outlet 52 to a third or holding tank 54 in which because of the production of sulfuric acid, the pH of the mixture will become approximately 1.5 to 3.0. The temperature in the holding tank 54 is held between 30° C. and 40° C. After the passage of a period of time sufficient for bacterial action to achieve the desired separation, the mixture exits the holding tank 54 and is directed into through an outlet 56 into a centrifuge 58 where the coal is separated from the aqueous mixture. The iron and sulfur components separated in the centrifuge 58 may be removed through conduits 60 and 62. For example the iron components can be withdrawn through conduit 60 and the sulfur components through the conduit 62. The hydrated coal particles exit the centrifuge 58 through conduit 64 and enter a fourth tank 66

A sulfuric acid by-product, i.e. H₂SO₄, may be removed from the fourth tank 66 through conduit 68 and separately utilized. Alternatively, sulfuric acid by-product may be directed through a conduit 70 into a fifth tank 72 where have its low pH raised to 6 or 7 by titration with phenophethalian solution and liquified calcium carbonate provided in the fifth tank 72. The hydrated coal particles are then moved out of fourth tank 66 through a conduit 74 as a coal slurry or fluidized bed, or direct boiler feed. Alternatively, the water is drained off and directed through a water conduit 26 back to the boiler 18 to be heated and reused as steam in the initial step of directing steam into the first tank 12 through conduit 20.

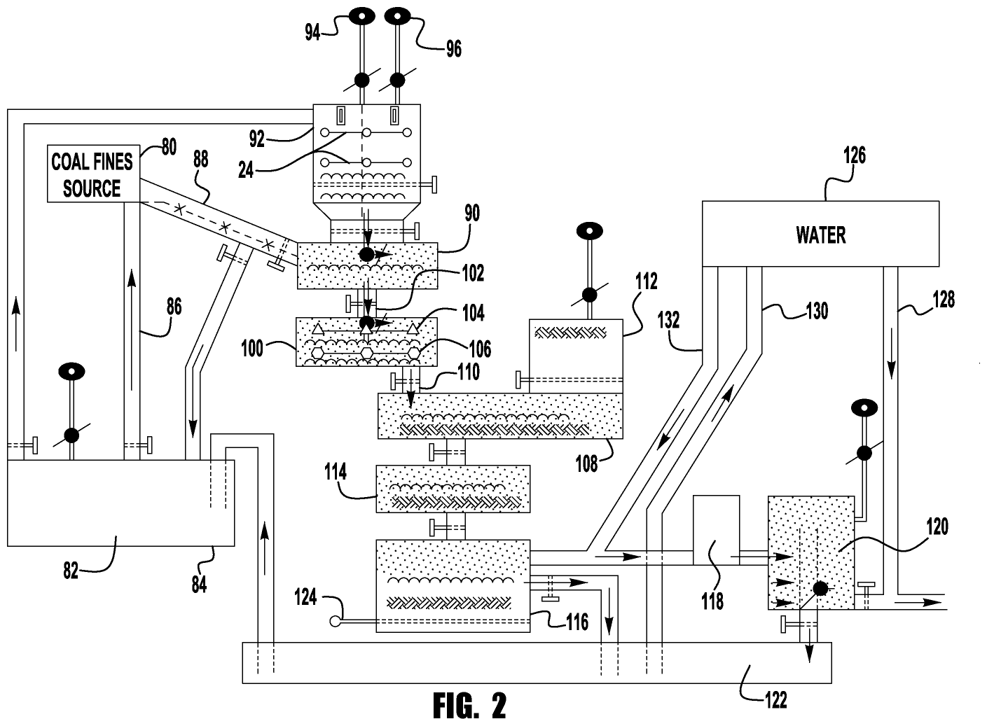

In the process of FIG. 2, coal fines stored in a tank 80 are mixed with acidified bog water 82 comprised of peat, sphagnum and spring water provided in a tank 84. The bog water is directed through a conduit 86 and into the tank 80. The mixture of coal fines and bog water are directed into a conduit 88 to a tank 90 where they are mixed with a culture from breeder tank 92 comprised of acidified bog water (pH 2-3.5, temp. 20°−30° C.) containing Thiobacillus ferrooxidans, T. thiooxidans, T. thioparus, T. acidophilis, T. neopolitanus, Euglena gracilis, E. acus, E. acus-(gracilis peat), E. mutabilis and others. Controls 94 and 96 are connected to tank 92 so that the temperature and pH can be continuously monitored and adjusted as needed. “Bog water” is generally a mineral water seasoned with peat and sphagnum having an acid pH. A sample analysis is set forth in following Table I identifying characteristics of a “new” bog (a fresh mixture of water, peat and sphagnum) and a mature bog comprising the same mixture aged at room temperature with aeration for a period of a month.

TABLE I

| | New Bog | Mature Bog |
|---|---|---|
| pH | 6.9 | 2.62 |
| Total Hot Acidity mg/L CaCo₃ | 8 | 381 |
| Mineral Acidity mg/L CaCo₃ | 8 | 381 |
| Total Alkalinity mg/L CaCo₃ | 110 | 1 |
| Total Fe ppm | 0.38 | 6.25 |
| Total Cu ppm | 0.14 | 0.19 |
| Al ppm | 1.09 | 6.90 |
| SO₄ ppm | 63 | 1,763 |
| Total P0₄ ppm | 1.89 | 4.37 |
| N0₃—N ppm | 5.96 | 0.516 |
| N0₂—N ppm | 0.04 | 0.04 |
| COD ppm | 705 | 674 |
| Spec. Cond. u hmos | 1,550,000 | 13,200 |

The presence of secondary bacterial forms, such as Beggiatoa, Sphaeotilus natans, Leucothrix, and Leptothrix, which are aerobic, like the Thiobacillus and will enhance the second oxidation phase, as will the facultative anaerobic Cyanochlorophyta alga, such as Oscillatoria, and the anaerobic photosynthetic bacteria found at low oxygen interfaces, such as Chromatium, Thiopedia, Thiospirillum, Chlorobium and Rhodospirillum. These former organisms, like the Beggiatoa and Leucothrix, ingest sulfur as granules, rather than chelate it prior to oxidation.

“Gro-lites” provide illumination in a spectrum pattern that stimulates photosynthetic bacteria and cause the Erylenoids to photosynthesize and produce nutrients and oxygen. This mixotrophic culture is ecologically balanced, synergistic, symbiotic and self-sustaining. The addition of catalysts, such as glutathione reductase, bovine cytochrome “C”, EDTA and Vitamin B₁₂ enhance and speed up life-sustaining, chelation and oxidation functions and since they are necessary for the reactions to occur, but not used up during the reactions, tend to be maintained over a period of 2-4 weeks before they need to be replenished or supplemented. After one hour in the first tank 90, the chelation of impurities is complete and low pH oxidation is well underway, due to the production of sulfhydrase and ferrooxidase enzymes produced by the Thiobacillus groups. T. ferrooxidans and T. acidophilis appear to be the main producers of the ferro-oxidases and smaller amounts of the sulfhydrases. T. thiooxidans and T. thiopanus appear to produce only sulfhydrases. T. neopolitanus appears to produce sulfhydrases and an enzyme of unconfirmed composition which, when present, speeds up and enhances the reproduction rates of the other four species of Thiobacillus. The oxidation process is further improved by the photosynthetic activity of the Euglenoid species.

The coal-fines mixture then passes into second tank 100 through a conduit 102. Yellow and green lights 104 and 106, respectively, disposed at 5 foot intervals around the tank 100 keep the oxygen production at a high level. The pH gradually increases to 3.5 to 4.5, which in turn activates the photosynthetic bacteria that ingest sulfur granules not yet oxidized. A lag phase of 20-30 minutes occurs, and the coal-fines mixture empties into third tank 108 through a conduit 110. Peat and sphagnum is introduced into third tank 108 from a vessel 112 and the oxidized impurities, now becoming entrapped in a “slime” lipophosphate mat, adhere to the sphagnum and peat. After one hour, third tank 108 empties into a fourth tank 114. Oxidation and deposition continue in fourth tank 114 for one hour. All of the first four tanks 90, 104, 108 and 114 rotate slowly to keep the contents well-mixed. This assures access of the bacteria to the coal-fines surface and inhibits the formation of the “mat” on the coal-fines.

The material then passes into a fifth tank 116 and then cleaned in a cyclone-centrifuge 118 which spins rapidly for about one hour to separate the coal-fines, “soup” and impurities-laden peat and sphagnum. The hydrophobic cleaned coal-fines move to a fourth flotation tank 120 or series of cells, where they are mixed with clean water for about one hour and then sent into slurry and blown with oil into the coal-users combustion unit. The “soup” is returned to the hydro-bog 82 in tank 84 after cleaning in a secondary water treatment tank 122. The impurity-laden peat and sphagnum are removed as by tray means 124 for processing back into reclaimed, reusable sulfur and heavy metals. A water source 126 for various process stages is shown interconnected to conduits 128, 130, 132.

When burned, the coal thus cleaned by the foregoing processes will not produce pollution as the iron and sulfur contaminants have been removed. Additionally, since the coal is “clean”, it is a more efficient energy source, as less of the coal needs to be combusted to create a given amount of energy.

Adaptions of the process include the removal of other unwanted materials, such as clay, by floculation immediately after the pulverization step. The system may be made anaerobic to accommodate chemolithotrophic anaerobes such as Desulfovibro and the system may be accommodated to other bacteria which remove other pollutants and contaminants, such as salt, copper, etc.

### Example I

A bench scale operation of the method is accomplished as follows:

Equal quantities of each of the certified bacterial strains Thiobacillus ferrooxidans, Thiobacillus thiooxidans, Thiobacillus thioparus and Thiobacillus acidophilis are added to a like quantity of Thiobacillus neopolitanus in the ratio of approximately 4,000,000 per ml. in acidified bog water. These bacteria cultures were obtained as verified strains from the American Type Culture Laboratories and Depository in Rockville, Md. The T. thioparus and T. ferrooxidans were provided live in vitro. The others were freeze dried in a skim milk culture and were prepared approximately two weeks before use. It is believed that the T. neopolitanus enhances the reproduction replication rate of the other bacteria, which in the above mixture have been observed to replicate ten times within a day, especially when “wild” cultures from active bogs are added to the ATCC cultures. In using the mixture of bacteria in the foregoing process, it is preferred to use a beginning solution of a concentration of approximately 106 to 1010 bacteria per 1 ml. of media. This range is approximate because individual bacteria vary in size. Other concentrations are feasible depending upon factors such as ultimate dilution of the slurry, proportions of coal fines introduced and relative impurity level in the coal. The suspected enzyme enhancing this phenomenon is as yet unconfirmed.

To the mixture of the bacteria in the bog water there is added a further volume of 10 ml. bog water medium and 0.5 gram glutathione reductase (an oxidizing sulfhydrase catalyst), 10 conventional hypodermic units of bovine cytochrome “C”, 1 gram of EDTA, 1 gram of Vitamin B12, and 10 grams of high sulfur coal. After a period of about four hours, oxidized sulfur in sulfate form is observed and iron is observed to separate from the mixture as a ferrous oxide, which become enmeshed in a “slime” lipophosphate mat. fines are observed to float to the top. In the bacteria action, the bacteria chelate and oxidize the sulfur and metal, which form a cohesive lipophosphate mat.

The coal fines used in the foregoing example range from 60 to −300 mesh and comprise a bituminous coal with a high iron pyrite contamination obtained in Perry County, Ohio from a glaciated formation including further deposits of lime-stone, dolomite, magnetite, J., limonit and sulfur at the terminal morine of the glacier. Upon combustion after drying, the coal separated in the foregoing example burned completely and left no residue.

### Example II

The procedure of Example I was followed using comparable fines of a pure “clean” Cannelton Coal from Fayette County, W. Va. No biological reaction occurred using this coal sample which did not have an iron pyrite component. The bacterial retained their original integrity.

### Example III

The procedure of Example I was followed using sulfur flowers and “pure iron pyrite” obtained from Carolina Biological Supply Co. in Burlington, N.C. and dibenzothiophene from Kodak. There was observed to be an extremely vigorous chelation and oxidation of the chemicals.

These Examples II and III provide positive evidence that the bacteria involved in the method and composition of the invention do in fact react with the iron pyrite and organic sulfur contaminants of a coal composition as is set forth in Example I.

Variations to the method, the biologically active agents used and the apparatus of the foregoing invention should be evidence to those of skill in the art.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

What is claimed is:

1. A system for separating coal from iron oxide, sulfur and other impurities, comprising:
a first tank receiving the coal from a conveyor belt;
a crusher to reciprocates into and out of the first tank while rotating to grind and shake the coal within the first tank;
a conduit to direct steam under pressure from a boiler into the first tank to mix with the ground and shaken coal to begin producing a maximum substrate area for chemolithotrophic bacteria and algal species to act upon;
a mechanical pulverizer apparatus being fed with the ground and shaken coal and steam at a first end and discharging the coal through a second end;
a sieve and a second tank receiving the ground and shaken coal the mechanical pulverizer apparatus;
an air exchanger and collection apparatus connected to the second tank by a conduit to collect nanosized particulates of coal;
a pipeline feeding the coal within the second tank containing a mixture of chemolithophic bacteria from a breeding tank;
a holding tank receiving the mixture of coal and chemolithophic bacteria;
a centrifuge receiving the mixture of coal and chemolithophic bacteria from the holding tank and then separating the coal from the mixture; and
a fourth tank to receive the separated and hydrated coal particles from the centrifuge.

2. The system for separating coal of claim 1 comprising four remote level indicators are mounted on the boiler for variable control of the steam being mixed with the coal.

3. The system for separating coal of claim 1 wherein the coal being discharged at second end of the mechanical pulverizer apparatus has a size of about 1 mm to 16 mm.

4. The system for separating coal of claim 3 wherein the mechanical pulverizer apparatus comprises a rotating cylinder.

5. The system for separating coal of claim 4 wherein the rotating cylinder contains steel balls of around 25 to 75 mm diameter.

6. The system for separating coal of claim 4 including a blower for directing larger pieces of coal collected on an upper surface of the sieve.

7. The system for separating coal of claim 1 wherein the mixture of chemolithophic bacteria within the breeding tank includes Thiobacillus thiooxidans, Thiobacillus ferrooxidans, and Thiobacillus thioparus, and the bacterium Thiobacillus neopolitanus.

8. The system for separating coal of claim 7 wherein the mixture of chemolithophic bacteria and coal has a pH of approximately 1.5 to 3.0.

9. The system for separating coal of claim 8 wherein the mixture of chemolithophic bacteria and coal in the holding tank is at a temperature in a range of between 30° C. and 40° C.

10. The system for separating coal of claim 1 wherein sulfuric acid by-product is removed from the fourth tank through a conduit and separately utilized.

11. The system for separating coal of claim 10 wherein hydrated coal particles are moved out of the fourth tank through a conduit as a coal slurry or fluidized bed, or direct boiler feed.

12. The system for separating coal of claim 11 wherein the coal-water slurry is moved into a neutralization tank for drying and compaction before combustion.

13. The system for separating coal of claim 11 wherein the coal-water slurry is moved into a neutralization tank for drying and compaction and mixed with oil and blown into the boiler.

14. The system for separating coal of claim 10 wherein water is drained off and directed through a water pipe back to the boiler to be heated and reused as steam in the initial step of directing steam into the tank through the conduit.

15. The system for separating coal of claim 1 wherein sulfuric acid by-product is directed through a conduit into a fifth tank where have its low pH is raised to 6 to 7 by titration with phenophethalian solution and liquified calcium carbonate provided in the fifth tank.

16. The system for separating coal of claim 1 wherein four remote level indicators are mounted on the boiler to allow for variable control of the steam in the boiler to increase the efficiency of the coal being mixed with the steam in the first tank.

17. The system for separating coal of claim 16 wherein a remote level indicator is disposed on an upper end of the boiler to allow the condition of the steam to be monitored.

18. The system for separating coal of claim 7 wherein the process of mixing of chemolithophic bacteria from the breeding tank is further improved by photosynthetic growth of algae of Euglena.

19. The system for separating coal of claim 1 wherein the iron and sulfur components separated in the centrifuge are be removed through separate pipelines.
